(19) United States
(12) Patent Application Publication
(10) Pub. No.: US 2004/0011168 A1
(43) Pub. Date: Jan. 22, 2004

(54) Paint masking

(76) Inventor: Robert E. Sears JR., Cordova, MD (US)

Correspondence Address: Thomas E. Beall, JR., 12445 Mill Creek Lane, Wye Mills, MD, 21679, US

(21) Appl. No.: 10/160,633

(22) Filed: May 31, 2002

(51) Int. Cl. B26D 1/00; B26D 3/00; B26F 3/02; B65H 35/10; B26D 7/00

(52) U.S. Cl. 83/13; 83/649; 225/39

(57) ABSTRACT

Sheet material is unrolled until a straight cut leading edge is at a predetermined desired length as measured along a scale, and so that a single tacky surface is on a planar support, for the unrolled sheet to lay wrinkle-free and planar in contact with the planar support surface. A cutter is translated along a guide entirely across the fixed width of the sheet material, thereby producing a linear straight line cut edge parallel to the straight cut leading edge at a predetermined desired length, thereby providing an accurate, dimensionally stable, abrasion resistant, single tacky side rectangular, planar sheet, mask that is then adhered to glass during surface finishing of frame portions adjacent to the mask. The cutter is slidablly mounted on a transverse pivotable guide rail to move away from the planar support surface sufficiently to remove the cutter as an obstruction to unrolling. In its operable position, the cutter blade extends within a linear, widthwise, slot of the planar support surface. The sheet material is an abrasion and tear resistant, abradable, non-stretching and dimensionally stable, composite with a permanent tacky adhesive on only its inner surface sufficient to provide non slip weak adhesion to the glass and easy manual removal from the glass.

### BACKGROUND OF THE INVENTION

This invention relates to the masking of glass and similar materials, for protection during subsequent preparation and coating of adjacent surfaces of support portions.

The U.S. patent to Ross et al, U.S. Pat. No. 5,441,769, issued Aug. 15, 1995, relates to a paint mask that is provided as a rectangular, planar sheet of flexible material having an attractiveness to glass, that is, an affinity for self-adhering to glass. The paint mask is pre-cut to one of the conventional size window panes and may be provided with score lines inwardly spaced from the edges so that the edge portions may be removed for other conventional sizes.

The U.S. patent to Nameche, U.S. Pat. No. 5,468,538, issued Nov. 21, 1995, discloses a paint masking kit and method of painting windows. A sheet can be removably adhered to a glass window pane. This sheet material can be in a roll and can be cut to fit any size and shape window glass. The material is preferrably a vinylic material with a thickness of 0.001 to 0.0045 inches and has a plasticizer to enhance pliability. Adhesive may be provided on one side of the sheet material.

The U.S. patent to Winston, U.S. Pat. No. 5,307,717, issued May 3, 1994, discloses a dispensing carrier and cutting guide for rolled plastic sheeting, which is used for masking. The rolls may be provided in various widths. A holder for a pair of scissors and a holder for a retractable tape measure are provided at a side of the carrier.

### SUMMARY OF THE INVENTION

The present invention provides for in situ cutting of more accurate and more reliable masks, particularly for the masking of rectangular window panes that vary in size even among nominally standard windows, and which is suitable for both preparation and subsequent coating.

The present inventor has analyzed the above prior art to discover problems, has identified and analyzed causes of the problems, and provided solutions to the problems. The discovery and analysis of the problems, the identification and analysis of the causes, and the provision of solutions are each parts of the present invention.

The above mentioned prior art discloses are not suitable for the in situ accurate and reliable masking of rectangular window panes that vary in size even among nominally standard windows, for both preparation and subsequent coating.

There has been a long felt need for the masking of surfaces to protect them from being painted, for example, as set forth in the U.S. Patent to Farrel, U.S. Pat. No. 1,683,453, issued Sep. 4, 1928. The Farrel disclosure is of a tacky adhesive applied to one side of paper that is then rolled with a release sheet to prevent the rolled sheet from excessively adhering to itself and to protect the adhesive, for example, to protect the adhesive from moisture. A separate release sheet is an added expense, requires a handling step and most be disposed of on site. The paper is unrolled for use and there are no disclosed specifics of how to divide the sheet. It is the primary object of the present invention to satisfy this long felt need of providing reliable window pane masking.

The paint mask of the U.S. patent to Ross et al, U.S. Pat. No. 5,441,769, issued Aug. 15, 1995, has problems recognized in the patent itself and recognized by the present inventor. No cutting apparatus is disclosed in the Ross patent and the masks are reuseable, which implies that the pre-cutting is performed at a mask producing factory, not at the painting site. The patent states that in use, air bubbles were observed trapped between the paint mask and the glass pane and that a squeegee was rolled across the paint mask to drive the air bubbles out. The patent also states that the paint mask did not appear to be in sealing contact with the glass pane against the caulk; therefore, a squeegee or roller was moved across the paint mask to try to secure the edges of the paint mask. The use of extra tools is an annoyance in that the tools become misplaced and tool usage require a skilled worker for masking. When the mask does not reliably cover the glass pane, paint must later be removed, a process that may scratch the glass window pane and require that the glass window pane be replaced at a further added expense. Objects of the present invention are to reduce the tools and skill required in masking, and to more accurately mask for both preparation and coating, without requiring skilled follow-up paint removal or glass replacement.

The inventor has found that such a mask as disclosed in the Ross et al patent, while having some advantages, has sufficient disadvantages that it is not used in the field. As the patent states, the mask is pushed against the caulk, but a problem is that the caulk may cover more or less of the nominally same sized pane from one window to another, depending upon prior glass replacement, different caulkers, uneven shrinking of the window sashes and/or calk due to differing exposures to the sun (southern exposure causing more shrinking than northern exposure, in general) and for other reasons. Thus for a house having only one nominal size window, there are commonly panes of considerably varying size, for example three sizes, sufficient to prevent the practical use of pre-cut as opposed to in situ cut masks for a quality paint job, particularly with respect to an older house. It is an object of the present invention to provide accurate in situ cutting of the glass pane mask in order to accurately adapt to on site conditions.

The necessary thinness and pre-cut nature, render the Ross mask inadequate to accomodate differently caulked or sized exposed glass window panes. The score lines of the Ross patent provide gross size adjustment for different nominal size panes, but cannot solve the above-mentioned problem of size variation within a single nominal size. The patent scoring has a purpose of weakening the sheet for easy tearing off of the border portions for window pane nominal size adjustment, but this creates considerable problems that would make such a tear-off structure impractical to use. When using the above mentioned squeegee, the sheet is likely to tear at the score lines and expose the glass to paint. Again, a high degree of skill is required with Ross. Also, manufacturing costs of the masks are higher. It is an object of the present invention to provide a reliable masking that does not require application tools, high cost or increased application skill.

It is noted that the Ross patent mask is of a vinyl having a thickness of 0.01 inches to 0.013 inches and with a self affinity for glass. That is, Ross employs a plastic film without any adhesive, which is disclosed as being used only during painting with a brush; the inventor's experience with such a mask is that it cannot be used during surface preparation. The thin plastic film is easily torn during sanding, particularly when it gives the person who is doing the sanding a false sense of security to be less careful in the sanding, which has resulted in builders and painting contractors having to replace many scratched panes of glass. The score lines of Ross only increase the problem. Sandpaper or steel-wool will catch on the film and tear the film of plastic, thus exposing the glass beneath to the subsequent coating, for example, painting. It is an object of the present invention to provide a reliable mask, which object is implemented by use of a sheet material that is suitable for surface preparation masking, particularly to be abrasion and tear resistant to a greater extent than a corresponding thickness of plastic of the type used in the prior art. The sheet material of the embodiment has an exposed surface that wears away with abrasion, as opposed to tearing, with the normal use of sandpaper and steelwool.

Another disadvantage of the plastic film of the prior art, such as Ross, is that the plastic film may dissolve with the use of preparation solvents to produce a solvent-adhesive-plastic coating on the unpainted adjacent surfaces that may not adhere to paint or produce a film on the glass that is difficult to remove. Many times, solvents are used in place of or in addition to sanding as a surface preparation prior to painting. It is noted that Ross only refers to painting with a brush and does not suggest that the film would be suitable as a sanding mask or as a mask for surface preparation with a solvent. Further Ross does not suggest the mask be used with respect to spray coating, where more solvent may be used than with brush painting. It is an object of the present invention to provide a mask that may be reliably used with the heavy application of solvents, for example during surface preparation or spray coating, which object is implemented by the use of a sheet material that is solvent resistant and is not a plastic film.

A thin plastic film, such as that used by Ross, is difficult to control, since both sides have an equal affinity for adhesion to glass. The necessary thinness to obtain to obtain the affinity to adhere to glass, makes the Ross mask film difficult to control during handling and application of the mask. As mentioned in the patent itself, the Ross mask traps air bubbles, which then requires additional tools and labor steps to remove the bubbles; the plastic film is no doubt easily displaced and stretches, all to produce an inaccurate masking or require considerable skill and time to apply. It is an object of the present invention to avoid plastic films as the sheet material, which object is implemented by using a composite sheet that may be abraded without tearing and handled without stretching during normal use.

The U.S. patent to Adams, Jr., U.S. Pat. No. 3,904,117, issued Sep. 9, 1975, discloses house painting apparatus for painting the support surfaces of a house adjacent masked windows, namely the walls in FIG. 3, and window frame support surfaces adjacent masked window panes in FIG. 2. The present invention is useable with such a painters boom and spraying equipment as that of the Adams patent, whose disclosure of such apparatus and spraying methods are incorporated by reference herein in their entirety. The disclosure of the Adams patent masks themselves is not incorporated herein. The present invention has proven to be very effective in test painting with HVLP, low pressure spraying equipment. It is an object of the present invention to provide a mask, a masking system and a masking method and that may be used reliably with paint spraying equipment.

The disclosed masks of Nameche, cited above, are described as precut panels of acetate or other transparent material adhered to the windows to cover the panes of glass and that the adherence is preferably by double-faced tape. Thus the masks of the Nameche patent have most of the problems discussed above with respect to the Ross et al patent relating to the use of a plastic film and in addition have the problem of using a separate masking tape. The use of a separate masking tape is time consuming, requires additional skill and expense, and in fact shows dissatisfaction with the self adherring qualities of a sheet plastic that has an affinity to adhering to glass. It is an object of the present invention to avoid thin plastic films and separate masking tape, which object is implemented by the use of a tacky adhesive on only one surface of the sheet material and avoid the problems of separate masking tapes and plastic films.

The U.S. patent to Nameche, mentioned above, employs a sheet material cut to fit a window glass, but as stated therein, the sheet material is applied over glass by pressing the plastic sheet over the window glass and using a knike or the like to trim the material at the corners, to thereby expose the window frame for painting. The use of a knive on the window glass will scratch the glass, which is highly noticeable when the sun hits the window at particular angles. Scratches may require the replacement of glass panes. It is an object of the present invention to avoid the use of tools in placing a mask on a pane of glass, particularly to avoid the use of a knife to cut the mask against the glass itself, which object is implemented in the present embodiment by a cutter mounted on the sheet material dispenser.

Although it is known to cut a mask from roll sheet material at a job site, in situ, prior to application of the mask, no one has used a cutter apparatus having a support surface and a cutter for accurately cutting straight linear square cuts of a desired accurately measured size, as is accomplished in the present invention. This is an object of the present invention.

Apparatus having a serrated tear edge for roll sheet material used for the paint masking of glass are known, for example as shown in the Japanese patent No. 10-277451, assigned to Intech, dated Oct. 20, 1998. The Japanese patent No 8-24733, dated Jan. 30, 1996, to Sugihara et al, discloses unrolling adhesive tape, presumably double sided adhesive tape, to be stuck to respective side edges of a sheet, all prior to a length being cut off on what appears to be a serrated fixed cutter blade. However, the inventor has found a serrated torn edge (in contrast to the linear straight cut edge of the present embodiment) is unsatisfactory for a quality paint job in that the paint edge is correspondingly of a serrated shape at best and at worst the paint edge smudges due to the points of the serrations lifting to guide and wick paint beneath the sheet. The inventor has used such apparatus with a serrated edge and sheet material in masking the glass of a car and masking building windows, and the inventor has found the above problems to be caused by the serrated edge. It is an object of the present invention to provide a straight clear paint edge, which is implemented with a guided, in situ, cutter blade that produces a straight cut edge of the mask.

The patent to Winston, cited above, addresses the problem of dispensing masking material. Winston provides for cutting roll plastic with a cutter, which is disclosed as a scissors or knife. However, Winston is only interested in gross covering of large areas and this difference from the present invention makes it clear that the cut edge of the Winston mask has no advantage over a serrated edge of the prior art for such gross masking. While different widths may be accomodated, particularly with a spacer, the widths are not precisely matched to the widths of glass surfaces, such as window glass, to be masked. No details of the plastic sheeting are disclosed. The Winston device will not obtain accurate, in situ, cut edges for the following reasons: the scissors would wobble when the guide groove is used; there is no specific teaching with respect to the use of a knife; the table is not meant to hold the cut sheet, because it is very short in length, particularly relative to the express purpose of large sheet masking; and plastic stretches, bunches and is otherwise difficult to manipulate for an accurate cut with such a device. It is an object of the present invention to obtain accurate square in situ cuts.

Winston has a purpose of obtaining a reliable and accurate measuring means, but this purpose is with respect to large area masking. Thus the terms reliable and accurate must be interpreted according to the desired accuracy of the usage. While Winston may meet such a purpose with large area masking, reliability and accuracy would not be obtained were the Winston teachings used in masking window panes. The tape measure of Winston is held by its spring clip (designed to engage a users belt), which would not accurately secure the tape, but this is of no consequence as the tape measures from the previously cut edge back to the guide groove. It would appear that the user would need to pull the tape out with one hand while pulling the plastic sheet out with a second hand, which means that the user most have an assistant or release something in order to pick up a cutter and then concentrate on using the cutter basically freehand with some assistance from the guide groove. The device of Winston is not suitable for accurate cutting of rectangular masks for window panes and is not intended for such usage. It is an object of the present invention to provide for reliable and accurate masking of glass window panes.

The patent to Yamazaki, U.S. Pat. No. 4,949,617, issued Aug. 21, 1990, disclosed an adhesive backed masking material in roll form to be dispensed and cut by a reciprocating cutter, but there is no accurate way to measure the cut piece; therefore, any inherent accuracy obtsained by the cutter is immaterial because the material is not measured accurately. The term paper is broadly used in the patent and not according to its conventional usage, because the material is a thin sythetic resin film, that is, plastic. The object of obtaining an accurate cut with the present invention is obtained by combining a reciprocating cutter, an accurate scale, a support table that will securely hold the sheet material because its adhesive side is down on the table, and a sheet material that is dimensionally stable.

The U.S. Pat. No. 5,947,881, to Fournier, issued Sep. 7, 1999, discloses a dispensor for rolled material as a pre-mask, and purports to disclose a slitter. This disclosure does not solve the problems of the prior art mentioned herein.

The material thickness of the Nameche patent, cited above, and the plasticizer to enhance pliability as disclosed therein produce a dimensionally unstable sheet for the expressly taught purpose that allows for a user to pull and stretch the material into corners without tearing, while providing enough strength to prevent paint sprayed onto the window from penetrating to the window glass. Thus, Nameche implies that without the plasticizer, the plastic is easily torn even with use only as a painting mask. Like the above-mentioned patent materials, the material of Nameche is only for painting protection; Nameche is specifically for spraying; the inventor's experience with such a mask is that it cannot be used during surface preparation, because the film is easily torn during sanding, particularly when it gives the sander a false sense of security to be less careful in the sanding, which has resulted in builders and painting contractors having to replace many scratched panes of glass. This is a particular problem with the use of unskilled labor.

Further, the prior art plastic film may dissolve with the use of preparation solvents to produce a coating on the unpainted adjacent surfaces; therefore, paint may not adhere. Also the coating may produce a film on the glass that is difficult to remove. Paint solvents, as well as preparation solvents, may distort the plastic so that it will no longer adequately mask the glass for second and subsequent coats.

A further problem that the inventor has encountered with plastic sheet material is that overspray paint does not adhere readily to the plastic film without dripping to the adjacent surfaces being painted, which therefore requires the application of a preliminary fog coat of paint to the mask, followed by a drying time preparatory to later actually starting the painting of the adjacent glass supports.

These and many other problems are addressed and solved with the embodiment of the present invention.

In a preferred embodiment of the the present invention and best mode of carrying out the the present invention, non plastic paper sheet material is unrolled until a straight cut leading edge is at a predetermined desired length as measured along a scale on one or each side. The inner tacky surface is unrolled onto a planar support, for the unrolled sheet to lay wrinkle-free and planar in secure non-shifting adhesive contact with the planar support surface. A cutter is mounted for translation only on and translated along a guide entirely across the fixed width of the sheet material, thereby producing a linear straight line cut edge parallel to the straight cut leading edge at a predetermined desired length. The embodiment provides an accurate, dimensionally stable, abrasion resistant, single tacky side, rectangular, planar sheet, mask that is then lightly adhered to the glass window pane during the surface finishing (preparation and/or coating) of the frame portions adjacent to the mask. The cutter is slidablly mounted on a transverse pivotable guide rail to move away from the planar support surface sufficiently to remove the cutter as an obstruction to unrolling the sheet material. In its operable position, the cutter blade cutting edge itself extends within a linear slot of the planar support surface to be accurately guided in addition to the guiding of the cutter blade as a whole. The sheet material is an abradable, abrasion resistant and tear resistant composite with a permanent tacky adhesive on only its inner surface sufficient to provide non slip weak adhesion to the cutter table, non slip weak adhesion to the glass and easy manual removal from the glass.

The embodiment provides solutions to the problems identified by the inventor with respect to the prior art that has addressed the same need for paint masking glass, and solutions flow from the inventor identified and analyzed causes of such problems. Thereby, the identification or recognition of problems and their causes, as well as their analysis are parts of the present invention.

### BRIEF DESCRIPTION OF THE DRAWING

The present invention is illustrated by way of example and not by way of limitation, in the figures of the accompanying drawing, in which like reference numerals refer to similar elements. Further objects, features and advantages of the present invention will become more clear from the following detailed description of a preferred embodiment and best mode of implementing the invention, as shown in the drawing, wherein:

FIG. 1 is a perspective view of the roll sheet material and cutter apparatus used in the present embodiment to cut masks in situ; and

FIG. 2 is a flow chart of the method of the present embodiment that uses the cutter apparatus of FIG. 1.

### DETAILED DESCRIPTION OF THE PREFERRED EMBODIMENT

In the following description, for the purposes of explanation, numerous specific details are set forth in order to provide a thorough understanding of the broader aspects of the present invention as well as to appreciate the advantages of the specific details themselves according to the more narrow aspects of the present invention. It is apparent, however, to one skilled in the art, that the broader aspects of the present invention may be practiced without these specific details or with an equivalent arrangement as guided by the problem, cause, solution analysis set forth herein and the examples, variations and other embodiments mentioned specifically. Well-known structures and devices are not shown in extreme detail to avoid unnecessarily obscuring the present invention with unnecessary details of well known technology.

The disclosure of a paper sheet material in the patent to Farrel, U.S. Pat. No. 1,683,453, issued Sep. 4, 1928, is encorporated herein in its entirety as an example of the embodiment base sheet material to which is applied an adhesive, not specifically disclosed in Farrel. The present embodiment does not need and does not employ a release sheet as in Farrel, that is the embodiment sheet is rolled so that it is in direct contact with itself.

Adhesive is provided on one side of the embodiment sheet material prior to being rolled. The disclosure of the adhesive at column 4, lines 22-30, of Nameche U.S. Pat. No. 5,468,538, issued Nov. 21, 1995, is encorporated herein in its entirety as examples of adhesives that may be used in the present invention.

The preferrred sheet material of the present embodiment is used as a transfer sheet in the signage field, wherein preformed individual plastic letters are arranged on the tacky side up of the sheet, and then the assembly of letters and sheet are moved and inverted so that the letters may be permanently adhered on their side opposite to the sheet onto a permanent mounting surface, for example a wall, with the use of a permanent adhesive; and after any necessary setting period, the transfer sheet is removed. This sheet material has not been used in the masking field to the knowledge of the inventor, who has worked in both fields.

The present invention uses a simple dispensing and cutting device that is well adapted to in situ use by being light weight, simple, portable, and easy to use by one person, while at the same time providing accurate cutting of rectangular masks suitable for the accurate and reliable masking of window panes of glass during both preparation for painting and the painting itself, whether by brushing, spraying or other coating means. Such cutters have been well known in other fields of use for a long time without being used in the paint masking field, for example: Smith, U.S. Pat. No. 228,686, issued Jun. 8, 1880; Smith, U.S. Pat. No. 231,857, issued Aug. 31, 1880; and Kress, U.S. Pat. No. 2,393,384, issued Jan. 22, 1946. Other cutters, for example Spehar, U.S. Pat. No. 5,056,729, issued Oct. 15, 1991, are too complicated and large for in situ use.

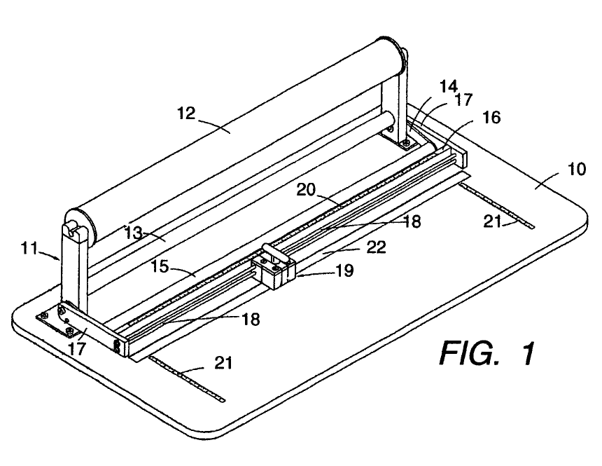

The preferred embodiment of the dispenser and cutter provided and used by the present invention is disclosed in FIG. 1, and the details thereof may be obtained from the U.S. Pat. No. 5,103,710, to Ross, issued Apr. 14, 1992, whose disclosure is incorporated herein in its entirety. The Ross cutting device is disclosed as being usable in the cutting of wrapping media, which is a use not analogous to the use in the present embodiment.

A mask dispensing, measuring and cutting apparatus for use in surface finishing frame portions of a glass holding frame and for protecting adjacent glass during the surface finishing is shown in FIG. 1.

A roll 12 of sheet material is of a fixed width and indefinite length, with a straight cut leading edge perpendicular to its length, of a single thickness rolled in direct contact with itself, and being a nonstretchable, abrasion and tear resistant, abradable, composite with a permanent tacky adhesive on only one surface sufficient to provide non slip weak, i. e., tacky adhesion to the glass for easy manual removal from the glass. A fixed axis rotatable mount 11 is provided on a table 10, which is a planar support surface, at each side of the roll, for mounting the roll 12 of sheet material rotatably about its axis. The mounts 11 are interconnected by a brace 13.

The cutter apparatus mounts a cutter blade 19 on two transverse guide rails 18. The guide rails 18 are parallel to each other and the axis, and are rigidly mounted at opposite ends to two pivotally mounted arms 17, respectively. The arms 17 are pivoted to the mounts 11 and therefore to the planar support surface 10. The guides 18 slidably mount a cutter blade 19 to thereby pivot from an operable position, shown in FIG. 1, wherein the cutter blade cutting edge extends within a linear slot 22 of the planar support surface 10, which slot 22 extends in the width direction of the roll 12 of sheet material. From the operable position, the cutter 19 and rails 18 may pivotally move, counterclockwise as seen in FIG. 1, with the arms 17 to a stable self holding sheet material unrolling position, not shown, that is at least ninety degrees from the operable position. Thereby, the cutter 19 is mounted and guided, when in the operable position, for linear movement across the planar support surface 10 in a cutting direction perpendicular to the length dimension measuring scales 21, parallel to the axis and at zero length as defined by the length dimension measuring scales 21.

The length dimension measuring scale 21 is fixedly mounted on the planar support surface or table 10, preferably on each side of the table 10, to extend perpendicular to the axis.

By translating the cutter 19 entirely across the fixed width of the sheet material in the cutting, a linear straight line cut edge parallel to the straight cut leading edge at a length dimension from the straight cut leading edge equal to a predetermined desired length, provides an accurate, dimensionally stable, abrasion resistant, single tacky side, rectangular, planar sheet, mask.

The cutter 19 and the guide rails 18 being movable away from the planar support surface prior to unrolling the sheet material, sufficiently removes the cutter 19 and guide rails 18 as an obstruction to the unrolling. A hold-down member 15 is mounted on swing arms 14 to be similarly rotated to an out of the way position, and thereafter moved down onto the non-tacky side of the sheet material to hold the sheet material tacky side onto the table reliably for the cutting operation, although with the tacky adhesive, the structure 14, 15 is not necessary.

The linear slot 22 is preferably a V-shaped croove in the planar support surface 10 and extends in the width direction of the roll 12 of sheet material. The guide rails preferably slidably carry the cutter 19 so that in the operable position, the cutter blade cutting edge extends within linear slot 22.

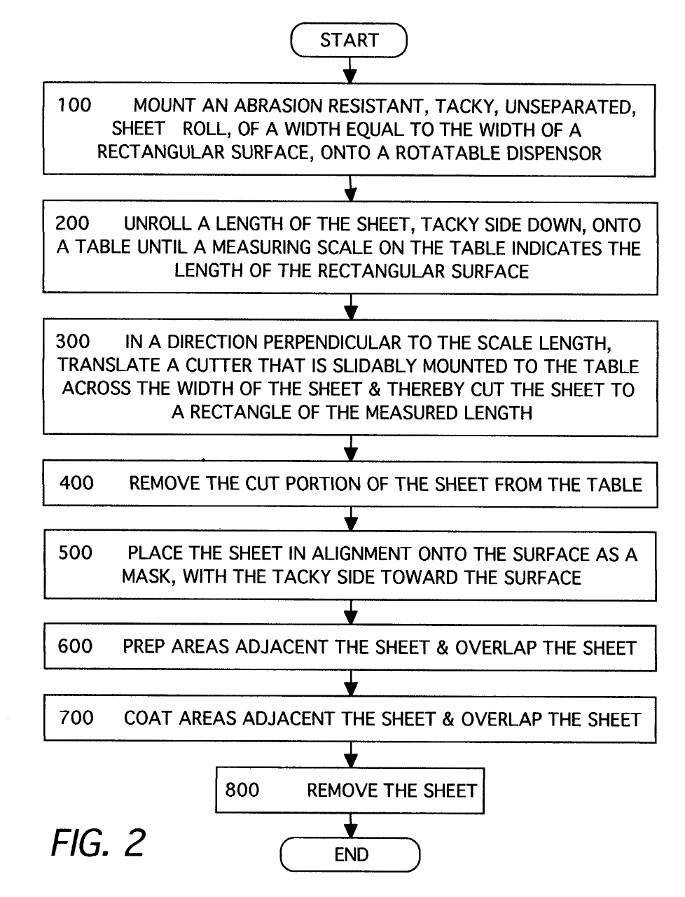

FIG. 2 is a flow chart of the method of the present embodiment that uses the cutter apparatus of FIG. 1, for surface finishing frame portions of a glass holding frame and protecting adjacent glass during the surface finishing, which method comprises the following steps:

Step 100: A roll 12 of sheet material is provided of a fixed width and indefinite length, with a straight cut leading edge perpendicular to its length, and of a single thickness rolled in direct contact with itself. The width of the sheet material is preferably that of the glass to be masked, and the rolls of the sheet material are provided in various widths for this purpose. Alternatively, the sheet roll may be cut on site before being mounted. The sheet material is a nonstretchable, abrasion and tear resistant, abradable, composite with a permanent tacky adhesive on only one surface sufficient to provide non slip weak and tacky adhesion to the glass to be masked, for easy manual removal from the glass. The roll 12 of sheet material is mounted by mounting arms 11, with braces 13, on the cutter apparatus of FIG. 1, to be rotatable about a fixed axis that is coextensive with the axis of the roll 12.

Step 200: A predetermined desired length of glass to be masked is measured. This length of the sheet material is unrolled, so that the tacky side of the sheet material is the side down onto the table 10 of the cutter apparatus. The predetermined length is measured by the length dimension measuring scale 21 on the planar support surface 10 running perpendicular to the axis of the roll 12. The sheet material of the roll 12 is thereby placed onto the planar support surface 10 using the length dimension measuring scale 21 so that the unrolled length of the sheet material that extends beyond the zero length of the length dimension measuring scale 12 in planar tacky contact with the planar support surface 10. The cutting of the sheet material to the width of the glass may be performed after unrolling or performed during unrolling by the use of a slitter blade, not shown in FIG. 1, such as the slitter blade 310 of the Spehar U.S. Pat. No. 5,056,729, issued Oct. 15, 1991, whose disclosure is incorporated herein in its entirety by reference for such. Prior to the unrolling, the cutter 19 may be moved away from the planar support surface 10 sufficiently to remove the cutter as an obstruction to the unrolling. Thereafter moving the cutter toward the planar support surface will place the cutter in an operable position.

Step 300: The cutter 19 is linearly movemed across the planar support surface in a cutting direction perpendicular to the length dimension measuring scale, parallel to the axis and at zero length as defined by the length dimension measuring scales 21. The cutter 19 is translated entirely across the fixed width of the unrolled sheet material in the cutting direction, thereby cutting the sheet material and producing a linear straight line cut edge parallel to the straight cut leading edge at a length dimension from the straight cut leading edge equal to the predetermined desired length, and thereby providing an accurate, dimensionally stable, abrasion resistant, single tacky side, rectangular, planar sheet, mask.

Step 400: The mask, which is the cut portion, is removed from the table planar support surface 10.

Step 500: The mask is aligned and adhered to the glass, with the tacky side contacting the glass.

Step 600: The support surfaces adjacent to the glass are then surface prepared, for example by sanding and or solvent wiping.

Step 700: The support surfaces adjacent to the glass are then coated, for example, they are brush painted or sprayed. Steps 600 and 700 are surface finishing of the frame portions adjacent to the mask.

Step 800. The mask is then removed from the glass.

Still other aspects, features, and advantages of the present invention are readily apparent from the following detailed description illustrating a particular embodiment implementation, including the best mode contemplated by the inventor. The present invention is also capable of other and different embodiments, and its several details can be modified in various respects, all without departing from the spirit and scope of the present invention. The drawing and description are illustrative, and not restrictive.

While the present invention has been described in connection with a number of embodiments, details, implementations, modifications and variations that have advantages specific to them, the present invention is not necessarily so limited but covers various obvious modifications and equivalent arrangements according to the broader aspects, which fall within the spirit and scope of the following claims.

1. A method of surface finishing frame portions of a glass holding frame and protecting adjacent glass during the surface finishing, comprising the steps of:
providing a roll of sheet material of a fixed width and indefinite length, with a straight cut leading edge perpendicular to its length, of a single thickness rolled in direct contact with itself, and said sheet material consisting of a nonstretchable, abrasion and tear resistant composite with a permanent tacky adhesive on only one surface sufficient to provide non slip weak and tacky adhesion to the glass for easy manual removal from the glass;
providing a cutter apparatus having a fixed axis rotatable mount for the roll of sheet material, a planar support surface, a length dimension measuring scale on the planar support surface running perpendicular to the axis, and a cutter mounted on a guide for linear movement across the planar support surface in a cutting direction perpendicular to the length dimension measuring scale, parallel to the axis and at zero length as defined by the length dimension measuring scale;
determining a predetermined desired length of glass to be masked;
unrolling the sheet material from the roll until the straight cut leading edge is on the planar support surface at the predetermined desired length as measured along the length dimension measuring scale;
thereafter, placing the outer surface onto the planar support surface using the length dimension measuring scale so that the unrolled length of the sheet material that extends beyond the zero length lays wrinkle-free, parallel to the length dimension measuring scale and planar in contact with the planar support surface;
translating the cutter entirely across the fixed width of the sheet material in the cutting direction and thereby cutting the sheet material and producing a linear straight line cut edge parallel to the straight cut leading edge at a length dimension from the straight cut leading edge equal to the predetermined desired length, and thereby providing an accurate, dimensionally stable, abrasion resistant, single tacky side, rectangular, planar sheet, mask;
adhering the mask to the glass;
surface finishing the frame portions adjacent to the mask; and
removing the mask from the glass.

2. The method of claim 1, further comprising:
said step of providing a roll of sheet material, providing the sheet material of the fixed width that is greater than the width of the glass; and
after said step of unrolling and before said step of adhering, cutting the sheet material to the width of the glass to have straight line parallel side edges.

3. The method of claim 2, wherein
said step of cutting the sheet material to the width of the glass is performed before said step of unrolling.

4. The method of claim 2, wherein

8. The method of claim 6, wherein
said step of providing a cutter apparatus slidably mounts a cutter b1 extends within a linear slot of the planar support surface that is in the width direction, pivotally to a stable self holding sheet material unrolling position that is at least ninety degrees from the operable position.

9. A mask dispensing, measuring and cutting apparatus for use in surface finishing frame portions of a glass holding frame and protecting adjacent glass during the surface finishing, comprising:
a roll of sheet material of a fixed width and indefinite length, with a straight cut leading edge perpendicular to its length, of a single thickness rolled in direct contact with itself, and consisting of a nonstretchable, abrasion and tear resistant, abradable, composite with a permanent tacky adhesive on only one surface sufficient to provide non slip weak and tacky adhesion to the glass for easy manual removal from the glass;
a fixed axis rotatable mount for mounting said roll of sheet material rotatably about said axis;
a planar support surface fixedly attached to said fixed axis rotatable mount;
a length dimension measuring scale fixedly mounted on said planar support surface and perpendicular to said axis;
a cutter mounted on a guide for linear movement across the planar support surface in a cutting direction perpendicular to the length dimension measuring scale, parallel to the axis and at zero length as defined by the length dimension measuring scale;
said cutter being mounted on said guide for translating movement entirely across the fixed width of the sheet material in the cutting direction and thereby cutting the sheet material and producing a linear straight line cut edge parallel to the straight cut leading edge at a length dimension from the straight cut leading edge equal to a predetermined desired length, thereby providing a an accurate, dimensionally stable, abrasion resistant, single tacky side, rectangular, planar sheet, mask;
said cutter and said guide being mounted on a movable mount secured to the table so as to be movable away from the planar support surface prior to unrolling the sheet material, sufficiently to remove said cutter and said guide as an obstruction to the unrolling; and
said cutter and said guide being mounted on said movable mount so as to be movable toward the planar support surface to an operable position prior to translating the cutter.

10. The apparatus in claim 9, further including
a linear slot in the planar support surface extending in the width di [symbol]
said guide being a transverse guide rail slidably carrying said cutter and being pivotally mounted to the planar support surface to pivot from the operable position, wherein the cutter blade extends within said linear slot, pivotally to a stable self holding sheet material unrolling position that is at least ninety degrees from the operable position.
